(19) United States
(12) Patent Application Publication
(10) Pub. No.: US 2015/0035435 A1
(43) Pub. Date: Feb. 5, 2015

(54) LIGHT SWITCH UNIT FOR CONTROLLING EXTERIOR LIGHTING OF A MOTOR VEHICLE

(71) Applicant: FORD GLOBAL TECHNOLOGIES, LLC, Dearborn, MI (US)

(72) Inventors: Michael ALBERTI, Duesseldorf NRW (DE); Sebastian BUMMEL, Koeln NRW (DE); Martin SCHECK, Pulheim NRW (DE); Thomas OELTJEBRUNS, Dormagen-Straberg NRW (DE); Frank AUST, Neuss (DE)

(21) Appl. No.: 14/449,234

(22) Filed: Aug. 1, 2014

(30) Foreign Application Priority Data
Aug. 1, 2013 (DE) 102013215104.7

(51) Int. Cl. B60Q 1/08; B60Q 1/076; B60Q 1/32; B60Q 1/00; B60Q 1/48

(52) U.S. Cl. CPC B60Q 1/08; B60Q 1/0076; B60Q 1/48; B60Q 1/32; B60Q 1/076; B60Q 2300/21; B60Q 2400/30
USPC 315/82

(57) ABSTRACT

A light switch unit for controlling the exterior lighting (such as headlights) of a motor vehicle. A rotary actuator can be rotated from a predefined home position into at least one deflected position, different lighting modes being assigned to the home position and to the at least one deflected position; the rotary actuator being mechanically biased to return automatically, after the rotation into the at least one deflected position, to the home position after which the lighting mode which is assigned to the respective deflected position initially remains activated.

### CROSS-REFERENCE TO RELATED APPLICATIONS

This application claims foreign priority benefits under 35 U.S.C. §119(a)-(d) to DE 10 2013 215 104.7 filed Aug. 1, 2013, which is hereby incorporated by reference in its entirety.

### TECHNICAL FIELD

The invention relates to a light switch unit and to a method for controlling the exterior lighting of a motor vehicle.

### BACKGROUND

Light switch units for controlling the exterior lights of motor vehicles are frequently embodied as rotary switches. Such a rotary switch can be actuated to select from available modes of the exterior lights, for example the modes “OFF”, “headlight ON”, “parking light”, “side light”, and “automatic” or “AUTO.” An “AUTO” mode refers to the vehicle lights being automatically switched on and off as a function of the ambient brightness.

The rotary switch is typically latched or locked mechanically in the respectively selected position. However, in practice this can lead to the exterior lights remaining unintentionally switched on after the vehicle is exited. Furthermore, a situation can occur in which the headlights are not switched on in situations in which they are required or remain unnecessarily switched on in other situations. Such situations may occur, in particular, in vehicles with LED daytime running light with a comparatively high light output, in which situations the driver is possibly given the impression, owing to the LEDs, that the dipped headlight is switched on.

Future Economic Commission for Europe (ECE) automobile regulatory standards may require automatic switching on and off of the vehicle headlights as a function of the current ambient brightness conditions. Furthermore, at any time manual activation or deactivation must be possible, for example, in situations in which the light sensor is not functionally capable. In this context, the problem occurs that in the case of a switch with respectively latched or locked switching positions there is no possibility of activating the vehicle headlights independently of the respectively selected light switch position. If, for example, the auto light is selected, it is difficult for the user to understand how the vehicle headlight can be switched off.

The scenarios described above either result in reduced vehicle availability (owing to a discharged battery), increased safety risks, increased fuel consumption, increased CO₂ emissions or failure to comply with future regulatory requirements.

DE 10 2009 000 536 A1 discloses a modular light switch unit for controlling lighting groups for a motor vehicle, in which light switch unit all the operator controls are embodied as pushbutton keys, wherein a main pushbutton key for switching the headlight on and off, which is enlarged compared to the other pushbutton keys, is surrounded by the other relatively small pushbutton keys. Using such pushbutton keys, which in contrast to conventional rotary, rocking or latching keys do not latch in a position which predefines an operating position of the assigned lighting mode, is intended to ensure that, for example when switching on the ignition of the motor vehicle, the control is operated in the “auto light” mode with the side light or headlight switched on as a function of the ambient light.

EP 1 074 429 B1 discloses a light switch unit, in which a rotary switch and at least two pressure switches, which are arranged essentially diametrically with respect to the rotary switch, are provided in order to form a direct relationship between the spatial arrangement and the function of the switches.

DE 10 2007 063 420 A1 discloses a method for switching off assistance light functions of motor vehicles, such as, for example, the rain light and the freeway light, in which selected assistance light functions (such as, for example, the tunnel detection system and the dusk detection system) remain activated.

WO 2006/084536 A1 discloses a method for activating headlights of a motor vehicle, in which method a manual mode with manual activation of the headlights by means of a selector lever and an automatic mode for activating the headlights on the basis of an exterior lighting situation are provided, wherein in the automatic mode an override possibility is provided, with the result that the headlights can be changed into the corresponding lighting state by manual activation of the selector lever independently of the exterior lighting situation.

### SUMMARY

An object of the present invention is to make available a light switch unit and a method for controlling the exterior lighting of a motor vehicle, which light switch unit and method permit, whenever the vehicle electrical system is switched on, automatic resetting to a predefined setting, and in this context may be readily understood and easy to operate by the user.

A light switch unit according to the invention for a motor vehicle has an actuator movable to actuate different lighting modes of the motor vehicle,

the actuator which can be moved from a predefined home position into at least one deflected position, different lighting modes being assigned to the home position and to the at least one deflected position;

the actuator returning automatically, after the movement into the at least one deflected position, to the home position after which the lighting mode which is assigned to the respective deflected position initially remains activated.

In the light switch disclosed herein it is ensured that the actuator is in its home position whenever it is not actively being moved by a vehicle occupant/driver. In this context, the lighting mode assigned to this home position may be the “auto” mode in which vehicle lights are automatically switched on and off as a function of the ambient brightness. This makes it possible that after each time the vehicle electrical system or the ignition have been switched on the exterior lighting control unit (ELCU) of the motor vehicle initially activates the “auto” mode.

The design of the light switch unit with a rotary actuator can be embodied, for example, in such a way that a center position is provided for the rotary actuator, an off position (which can be, for example, to the counter-clockwise or left of the center position) and an on position (which can be, for example, to the clockwise or right of the center position) are provided, in which cases the operator control process can take place in a way which corresponds to that in most customary exterior lighting switches in the region of the dashboard. With the light switch unit according to the invention, the user is therefore able to switch the headlights on and off in a similar way to what he is accustomed to.

In order to signal to the driver that the “auto light” lighting mode is activated, in which mode vehicle lights are automatically switched on and off as a function of the ambient brightness, in the light switch unit according to the disclosure a mode indicator is preferably provided. As a result, the driver is informed that the headlights are currently being controlled by the ELCU as a function of the brightness conditions in the surroundings.

If the driver wishes to change the state of the headlights or there is a need to do so, the rotary actuator can be briefly rotated into the corresponding deflected position, lying, for example, to the left or right of the home position, in order to switch the headlights on or off.

In addition, in the light switch unit according to the invention it is possible to provide one or more pushbutton keys for activating further lighting modes, wherein alternatively or additionally—depending on the design requirements of the light switch unit—the rotary actuator itself can also be configured with an (axial) pressure function. It is therefore possible, for example, for the parking light or the side light to be activated by using either an (axial) pressure function of the rotary actuator or a pushbutton key which is intended for this purpose. Whenever the parking light or the side light is required, the respective lighting mode can be activated by activating the rotary actuator or the pushbutton key which is provided for this purpose. Furthermore, automatic deactivation of the parking light or of the side light may occur when the rotary actuator is moved into its counter-clockwise or clockwise rotated position.

In order to activate the automatic lighting mode again after deactivation has previously taken place, in one embodiment of the light switch unit disclosed herein it is possible to provide, for example, a pushbutton key which is intended for this purpose. In a further embodiment, such renewed activation of the automatic lighting mode can take place on the basis of rotational activation of the rotary actuator, the rotary actuator having to be rotated, for example, into the on/automatic lighting position and held in that position for a specific time period (which exceeds the customary activation time period) in order to bring about renewed activation.

The displays for the other lighting modes (with the exception of the display for the “auto” mode) are preferably accommodated in the instrument panel for the purpose of optimum visibility. These displays are actuated by the ELCU in accordance with the activation state of the respective lighting mode.

According to one embodiment, the lighting mode which is assigned to a deflected position is an “ON” mode in which the headlight is switched on. Furthermore, the lighting mode which is assigned to a deflected position can be an “OFF” mode in which the headlights of the motor vehicle are switched off.

According to one embodiment, the rotary actuator can be rotated from the predefined home position into two deflected positions.

According to one embodiment, two different lighting modes are assigned to a deflected position, wherein the minimum activation periods which are respectively necessary for activating these two lighting modes, and for which the rotary actuator must remain in this deflected position for activating the respective lighting mode, are different from one another.

In this context, one of these two lighting modes can be a “auto light” lighting mode in which vehicle lights of the motor vehicle are automatically switched on and off as a function of the ambient brightness.

The invention also relates to a method for controlling the exterior lighting of a motor vehicle having a light switch unit, this light switch unit having at least one operator control for activating different lighting modes of the motor vehicle,

this operator control being embodied as a momentary-contact rotary actuator which is rotated from a predefined home position into at least one deflected position, different lighting modes being assigned to the home position and to the at least one deflected position;

the rotary actuator returning, after the rotation into the at least one deflected position, automatically into the home position after which the lighting mode which is assigned to the respective deflected position initially remains activated.

According to one embodiment, the lighting mode which is assigned to the home position is a “auto light” lighting mode in which vehicle lights of the motor vehicle are automatically switched on and off as a function of the ambient brightness.

According to one embodiment, when the vehicle electronics are switched on the lighting mode which is assigned to the home position is automatically activated.

The invention will be explained below on the basis of preferred embodiments and with reference to the appended figures, in which:

### BRIEF DESCRIPTION OF THE DRAWINGS

FIG. 1 is a schematic illustration depicting the design of a light switch unit according to a first embodiment of the invention;

FIG. 2 shows a logic diagram depicting the switching logic implemented by the light switch unit in FIG. 1 for the activation of the individual lighting modes;

FIG. 3 shows a diagram depicting a circuit which is suitable for the inventive rotary encoder of the light switch unit in FIG. 1;

FIG. 4 shows a schematic illustration depicting the design of a light switch unit according to a further embodiment of the invention;

FIG. 5 shows a logic diagram depicting the switching logic implemented by the light switch unit in FIG. 4 for the activation of the individual lighting modes; and

FIG. 6 shows a diagram depicting a circuit which is suitable for the inventive rotary encoder of the light switch unit in FIG. 4.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

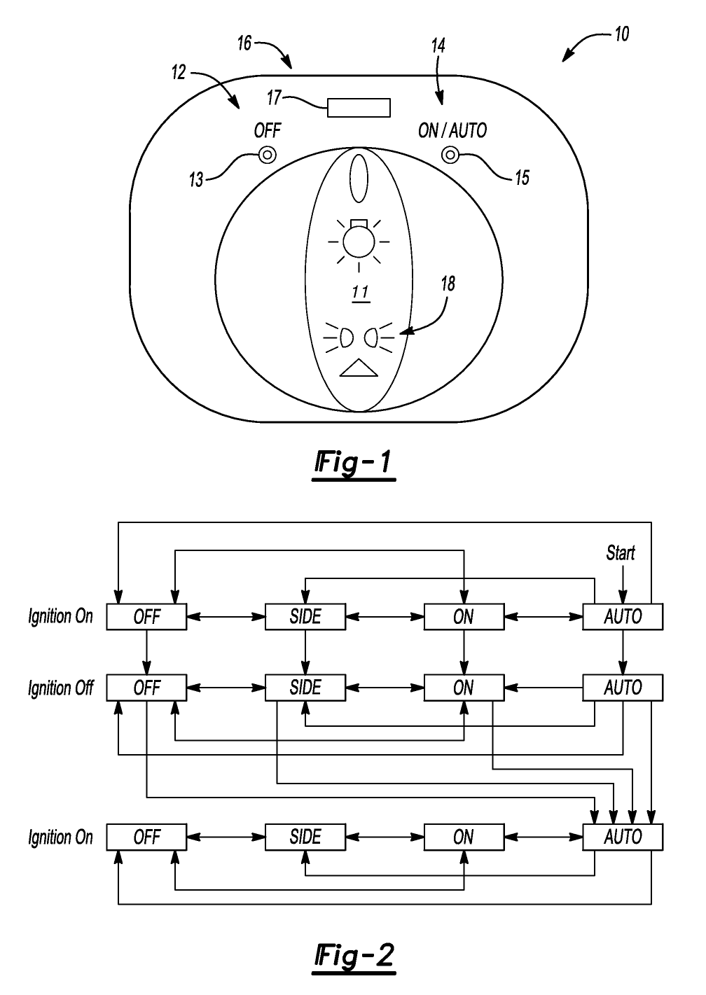

According to FIG. 1, a light switch unit 10 for use in a headlight control system has, in a first embodiment of the invention, a rotary actuator 11 which has three different rotational positions, these rotational positions comprising a home position 16 (center position), a first deflected position 12 (which can lie, for example, to the left of the center position or home position 16, and in the exemplary embodiment forms the “headlights OFF” corresponding to a state of the motor vehicle with switched-off headlights), and a second deflected position 14 (in the example the “on position” corresponding to the headlight lighting mode, in the exemplary embodiment to the right of the center position or home position 16).

The light switch unit 10 further has mode indicators 13, 15 and 17 which are assigned to the counter-clockwise rotated position 12, the clockwise rotated position 14, and the home position 16 (and therefore to the corresponding lighting modes associated with the three positions), respectively. In particular, in this context illumination of the mode indicator 17 signals that the “auto light” mode is activated. In this context, the ELCU causes the mode indicator 17 to light whenever the headlights are controlled on the basis of the brightness conditions of the surroundings. Whenever the driver uses the rotary actuator 11 to change manually the current status of the exterior lighting or to deactivate the automatic presetting, the mode indicator 17 is switched off.

The rotary actuator 11 which is rotated into one of the deflected positions in order to activate the respective lighting mode (for example headlights ON) returns to the home position after the actuator is released, and the lighting mode assigned to the deflected position initially selected remaining activated. On the other hand, when the vehicle electronics are initially switched on after having been de-energized for some period of time the lighting mode assigned to the home position 16 is activated automatically.

According to the embodiment in FIG. 1, the automatic lighting mode can be reactivated (after having been previously deactivated) by rotating the rotary actuator 11 into its second deflected position 14 and holding the actuator at the second deflected position for a period of time that is somewhat longer than is required to activate the headlight-on mode. This function may be indicated by the words “ON/AUTO” being associated with the second deflected position 14 and/or the mode indicator 15, meaning that turning the actuator to the second deflected position can result in selection of either the headlight-on mode or the automatic mode, depending upon the length of time the actuator is held in the deflected position.

Activation of the parking or side light occurs in the embodiment in FIG. 1 by virtue of the fact that an axial pressure function of the rotary actuator 11 is provided. Whenever the side light or the parking light is required, the respective lighting mode can be activated by using this axial pressure function of the rotary actuator 11. Furthermore, the parking light or the side light is deactivated automatically when the rotary actuator 11 is moved into its counter-clockwise or clockwise rotated position 12 or 14, respectively.

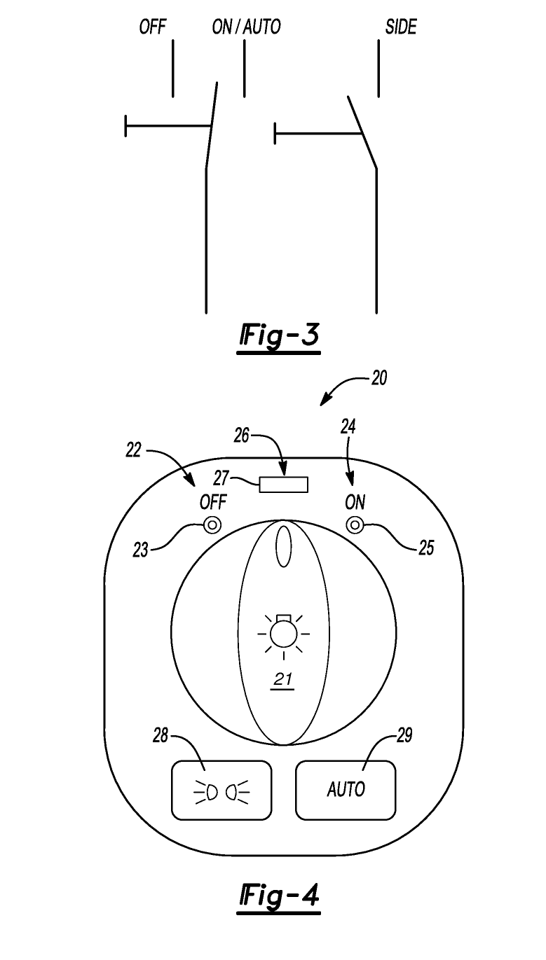

FIG. 2 shows a logic diagram depicting the switching logic implemented by the light switch unit 10 in FIG. 1 for operating the headlight control system to activate the separate lighting modes. When the vehicle ignition is switched on (or the vehicle electrical system is otherwise switched on prior to operation of the vehicle) so that the headlights are supplied with electrical power, the driver of the motor vehicle can switch over between the individual lighting modes using the rotary actuator 11, in the example “OFF”, “side light” (=“side”), “ON” and “auto”, wherein another lighting mode can be selected depending on the rotational direction of the rotary actuator 11 or else by pressure activation of the rotary actuator 11 (in order to activate the side light). FIG. 3 shows a circuit which is suitable for the light switch unit 10 in FIG. 1.

FIG. 4 shows a schematic illustration depicting the design of a light switch unit 20 according to a further embodiment of the invention, analogous or essentially functionally equivalent components compared to FIG. 1 being denoted by reference symbols increased by “10”.

The embodiment according to FIG. 4 differs from that in FIG. 1 in that a pushbutton key 29 is provided for the renewed activation of the “auto” lighting mode after deactivation of the “auto” mode has previously taken place by movement of the rotary actuator 12 away from the home position 27. Furthermore, in the case of the embodiment according to FIG. 4 for activating the side light (or the parking light), a pushbutton key 28 which is intended for this purpose is also provided. Whenever the side light or the parking light is required, that lighting mode can be activated by activating the pushbutton key 28 provided for this purpose. Furthermore, the parking light or the side light is deactivated automatically if the rotary actuator 21 is moved into its counter-clockwise or clockwise deflected position 22 or 24, respectively.

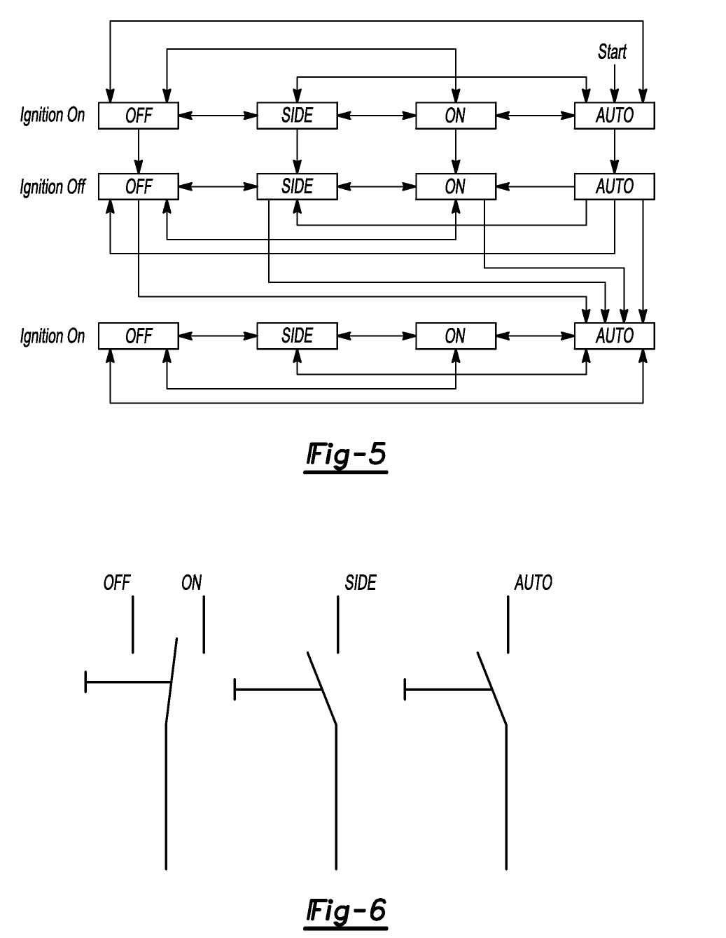

FIG. 5 shows (in a way analogous to FIG. 2) a logic diagram depicting the switching logic which is implemented by the light switch unit 20 in FIG. 4 for the activation of the individual lighting modes. When the ignition is switched on, the driver of the motor vehicle can switch over between the individual lighting modes, in the example “off”, “side light” (=“side”), “headlight” (=“head”) and “auto light” (=“auto”) by means of the rotary actuator 21, it being possible to select a different lighting mode depending on the rotational direction of the rotary actuator 21 or else by activating the pushbutton keys 28 or 29 (in order to activate the side light or for the renewed activation of the automatic lighting mode). FIG. 6 shows (in a way analogous to FIG. 3) a circuit which is suitable for the inventive light switch unit 20 in FIG. 4.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A control system for a motor vehicle having a headlight operable in an automatic mode, an ON mode, and an OFF mode, comprising:
an actuator rotatable between a center position, a clockwise-rotated position, and a counterclockwise-rotated position, the actuator spring-biased to return automatically to the center position when released after being rotated to either the clockwise-rotated or counterclockwise-rotated position; and
an electrical circuit associated with the actuator such that:
the automatic mode is activated when the headlight is initially supplied with electrical power;
rotation of the actuator to the clockwise-rotated position activates a first of the ON mode and the OFF mode;
rotation of the actuator to the counterclockwise-rotated position activates a second of the ON mode and the OFF mode; and
the mode activated by rotation to the clockwise or counterclockwise-rotated position remains activated after the actuator automatically returns to the center position.

2. The control system of claim 1, further comprising a mode indicator assigned to the automatic mode and associated with the circuit to produce a visual indication when the automatic mode is activated.

3. The control system of claim 1, wherein the circuit is further operable to, after activation of the ON mode or the OFF mode by the actuator being rotated to the respective position, return the headlight to the automatic mode in response to the actuator being rotated a second time to at least one of the clockwise-rotated and the counterclockwise-rotated position.

4. The control system of claim 1, wherein the actuator is further movable along an axis of rotation, and the circuit is further operative to activate at least one of a side light and a parking light of the vehicle when the actuator is moved along the axis.

5. The control system of claim 1, further comprising a pressure switch adjacent to the actuator, and the circuit is further operative to activate at least one of a side light and a parking light of the vehicle when the pressure switch is actuated.

6. A switch unit for controlling vehicle headlights comprising:
an actuator movable between a home position and a deflected position, the actuator mechanically biased to return to the home position after movement to the deflected position; and
an electrical circuit associated with the actuator such that a first operating mode is activated when the headlights are initially supplied with power, movement of the actuator to the deflected position activates a second operating mode, and the second mode remains active after the actuator returns to the home position.

7. The switch unit of claim 6, wherein the first mode is an automatic mode in which the headlights are automatically switched on and off as a function of ambient brightness.

8. The switch unit of claim 7, further comprising a mode indicator assigned to the automatic mode and giving a visual indication that the automatic mode is activated.

9. The switch unit of claim 6, further comprising a mode indicator assigned to the deflected position and giving a visual indication that the second mode is activated.

10. The switch unit of claim 6, wherein the second mode is an ON mode in which the headlights are switched on.

11. The switch unit of claim 6, wherein the actuator is further movable to a second deflected position to activate a third mode, the actuator mechanically biased to return automatically to the home position after movement to the second deflected position, and wherein the electrical circuit is further configured such that the third mode remains activated after the actuator returns to the home position.

12. A switch unit for selecting between operating modes of vehicle headlights comprising:
an actuator movable between a home position wherein a first mode is activated and a deflected position wherein a second mode is activated, the actuator mechanically biased to return to the home position after movement to the deflected position; and
a circuit configured such that the second mode remains activated after the actuator returns to the home position.

13. The switch unit of claim 12, wherein the first mode is an automatic mode in which the headlights are automatically switched on and off as a function of ambient brightness.

14. The switch unit of claim 13, further comprising a mode indicator assigned to the automatic mode and giving a visual indication that the automatic mode is activated.

15. The switch unit of claim 12, further comprising a mode indicator assigned to the deflected position and giving a visual indication that the second mode is activated.

16. The switch unit of claim 12, wherein the second mode is an ON mode in which the headlights are switched on.

17. The switch unit of claim 12, wherein the actuator is further movable to a second deflected position to activate a third mode, the actuator mechanically biased to return automatically to the home position after movement to the second deflected position, and wherein the circuit is further configured such that the third mode remains activated after the actuator returns to the home position.

18. The switch unit of claim 12, wherein after the actuator is moved to the deflected position to activate the second mode, a second movement of the actuator to the deflected position reactivates the first mode.

19. The switch unit of claim 12, wherein the actuator is a rotary actuator that is rotated about an axis between the home position and the deflected position.

20. The switch unit of claim 19, wherein the actuator is further movable along the axis and the circuit is configured to activate at least one of a side light and a parking light when the actuator is moved along the axis.
